(19) United States
(12) Patent Application Publication
(10) Pub. No.: US 2025/0307179 A1
(43) Pub. Date: Oct. 2, 2025

(54) INTERCONNECT FLOW-CONTROL CREDIT LOSS DETECTION

(71) Applicant: Intel Corporation, Santa Clara, CA (US)

(72) Inventors: Omar Jorge Avelar Suarez, Zapopan (MX); Claudia Patricia Barajas Rivera, Zapopan (MX); Diego Garcia Rodriguez, Guadalajara (MX); Theodros Yigzaw, Sherwood, OR (US)

(73) Assignee: Intel Corporation, Santa Clara, CA (US)

(21) Appl. No.: 18/622,140

(22) Filed: Mar. 29, 2024

(51) Int. Cl. G06F 13/14; G06F 13/42

(52) U.S. Cl. CPC G06F 13/14; G06F 13/4221; G06F 2213/0026

(57) ABSTRACT

Techniques for credit loss detection are described. In an embodiment, an apparatus includes an interconnect for transmitting data according to a credit-based protocol and a credit loss detector. The credit loss detector is to detect possible credit leaks by sampling credits available, comparing the credits available to credits programmed per sampling point, and maintaining a scoreboard of a result of the comparing per sampling point.

### BACKGROUND

Data communication protocols often implement credit-based flow control designs for efficient data transmission.

### BRIEF DESCRIPTION OF DRAWINGS

Various examples in accordance with the present disclosure will be described with reference to the drawings, in which:

FIG. 1A illustrates a system for credit loss detection according to embodiment.

FIG. 1B illustrates an example of a scoreboard for credit loss detection according to an embodiment.

FIG. 2A illustrates a configuration register for credit loss detection according to an embodiment.

FIG. 2B illustrates a status register for credit loss detection according to an embodiment.

FIG. 3 illustrates a method for credit loss detection according to an embodiment.

FIG. 4 illustrates an example computing system.

FIG. 5 illustrates a block diagram of an example processor and/or System on a Chip (SoC) that may have one or more cores and an integrated memory controller.

FIG. 6A is a block diagram illustrating both an example in-order pipeline and an example register renaming, out-of-order issue/execution pipeline according to examples.

FIG. 6B is a block diagram illustrating both an example in-order architecture core and an example register renaming, out-of-order issue/execution architecture core to be included in a processor according to examples.

FIG. 7 illustrates examples of execution unit(s) circuitry.

FIG. 8 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for interconnect flow-control credit loss detection. A feature or features supported by or implemented in a system, processor, etc. according to embodiments may be referred to as credit loss detection, lost credit detection, a credit loss monitor, etc. According to some examples, an apparatus includes an interconnect for transmitting data according to a credit-based protocol and a credit loss detector. The credit loss detector is to detect possible credit leaks by sampling credits available, comparing the credits available to credits programmed per sampling point, and maintaining a scoreboard of a result of the comparing per sampling point.

As mentioned in the background section, data communication protocols often implement credit-based flow control designs for efficient data transmission. For example, a credit-based protocol according to the Peripheral Component Interconnect Express (PCIe) specification involves external devices connected to a processor. Because a PCIe-based product may support a wide variety of devices and the specification spans multiple generations, there has been an incremental trend of device-induced failures in datacenters using these products. User debug, at-scale failures, and in-lab failures has shown that faulty devices which have not returned credits to the system and hang from system back-pressure contribute significantly to these failures. It may be difficult to diagnose a loss of credits without early-warning systems and error logging in these products. Such scenarios may also exist or develop with other standard protocols such as Compute Express Link (CXL), Universal Chiplet Interconnect Express (UCIe), etc. Diagnosing current credit loss problems in the lab and in the field may involve manual debugging with expensive protocol analyzers and/or unfriendly internal silicon snapshots at the point of failure of the queues and credits.

Therefore, the credit loss detection capability that may be provided by embodiments may be desired. Embodiments may utilize information about the link state and leverage a lightweight tracking solution that derives responses based on current credit information that provides credit loss alerts. Embodiments may provide user visible error signals, error logs, and diagnostics that may accurately reflect a richer root cause of credit loss by precisely detecting lost credits in the field and in a timely manner, thus serving as a protocol interface and external device monitor, providing an early failure warning, and increasing system uptime.

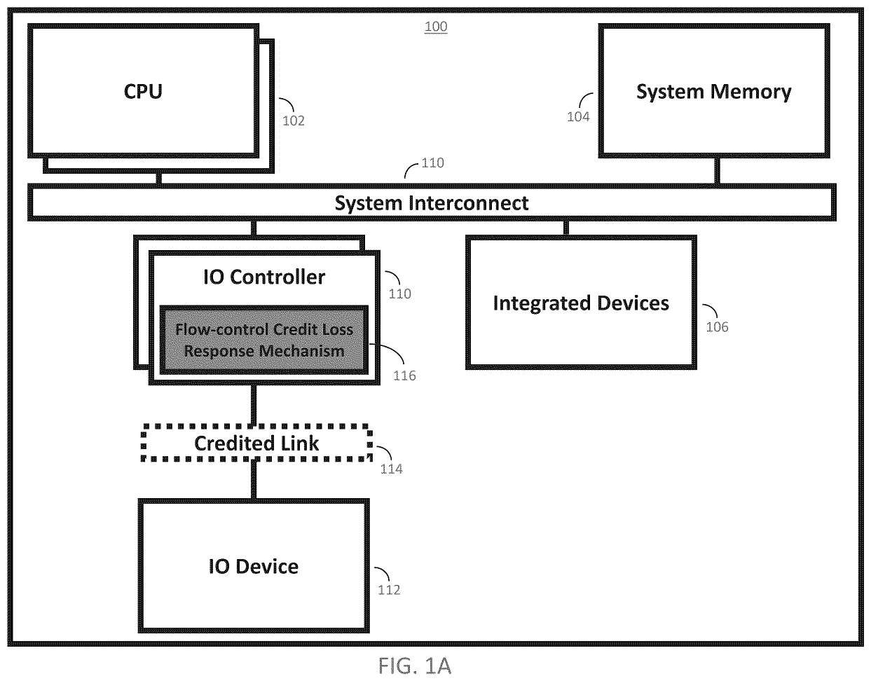

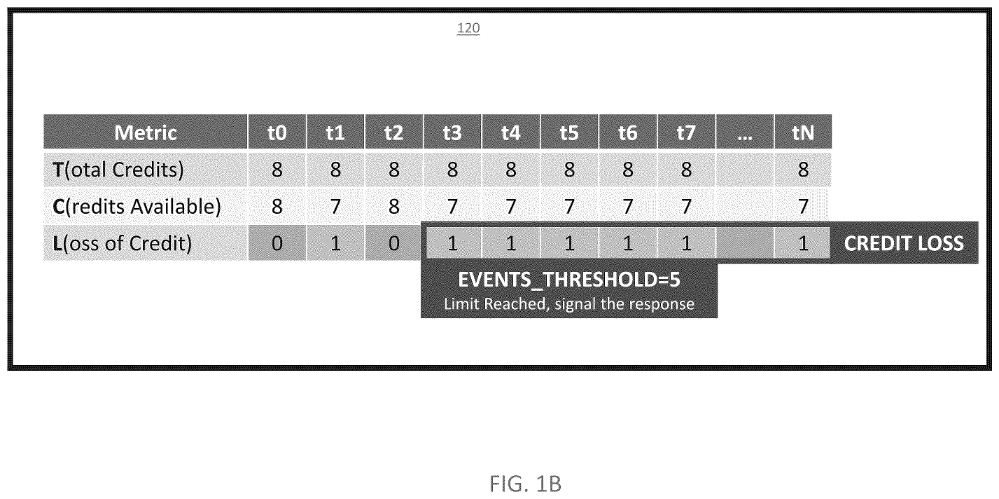

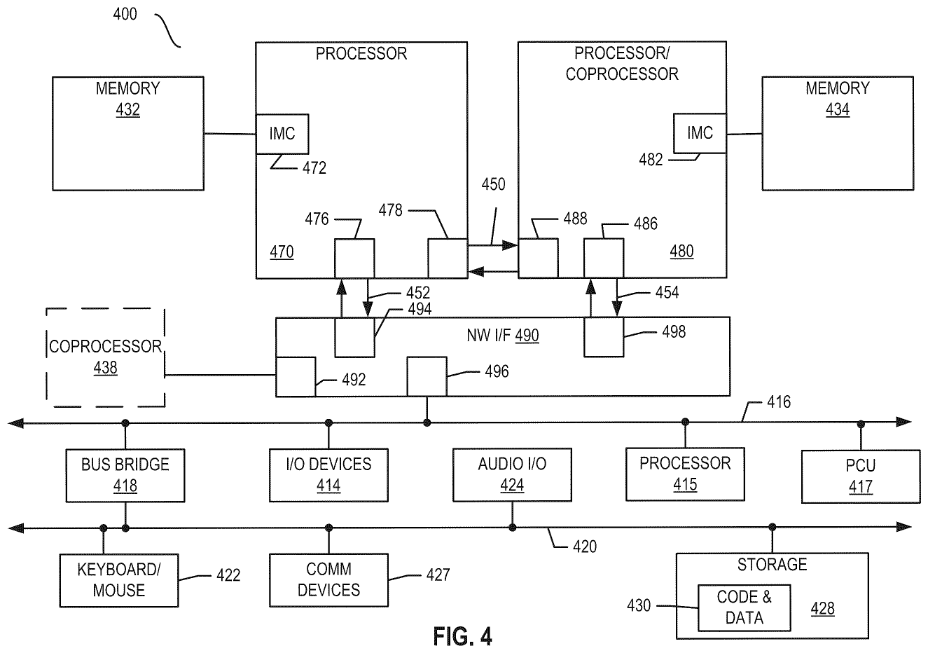

FIG. 1A illustrates a system 100 for credit loss detection according to an embodiment. System 100 may represent a server, computer system, information processing system, etc., such as system 400 in FIG. 4, as described below. As shown in FIG. 1A, system 100 includes any number of processors (e.g., central processing units or CPUs) 102, a main or system memory 104, any number of input/output (I/O) controllers 110, and any number of integrated devices 106. Processor(s) 102, system memory 104, I/O controller(s) 110, and integrated device(s) 106 are connected to each other through system interconnect 108. As shown in FIG. 1A, an I/O controller 110 is connected to an I/O device 112 through credited link 114; however, systems according to embodiments may include any number of I/O controllers connected to any number of I/O devices through any number of credited links.

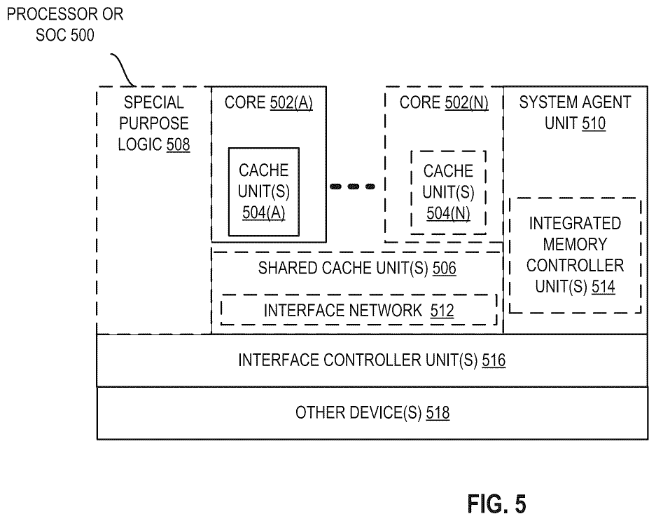

In various embodiments, any of processors 102 may correspond to any of processors 470, 480, or 415 in system 400 in FIG. 4 and/or processor 500 in FIG. 5, each as described below. System memory 104 may correspond to any or any combination of memories 432 and 434 in FIG. 4, as described below. Any of I/O controllers 110 may correspond to network interface 490 in FIG. 4, as described below. Any of integrated devices 106 and/or I/O devices 112 may correspond to any of the devices shown in FIG. 4, each as described below.

Shown for example in FIG. 1A as flow-control credit loss response mechanism 116 in I/O controller 110, a credit loss detector, monitor, mechanism, etc. according to embodiments may be implemented in circuitry, logic, structures, hardware, etc., all or parts of which may be included in an I/O controller, an interconnect controller, a bridge, and/or any other system component.

Flow-control credit loss response mechanism 116 or other credit loss detector, monitor, mechanism, etc. according to embodiments (for convenience, any of which may be referred to as a credit loss detector) may be implemented in any system using a credit-based protocol (e.g., for any interconnect, whether internal or external to a processor or processor core in the system). In embodiments, a credit loss detector may perform sampling based credit checks to predict, detect, monitor for, etc. a loss in system credits.

In various embodiments, the associated sampling techniques and sample points may vary. In embodiments, periodic credit checks and sampling is performed during idle states (e.g., in connection with idleness tracking to achieve low-power saving modes). In embodiments, the sampling action (e.g., on idle indicators) takes snapshots of the following information:
T:=the total number of credits programmed
C:=the number of available credits sampled at this idle event.
L:=is derived by the difference of T and C

In embodiments, a value of L that is greater than zero may be considered a possible credit leak. If L stays greater than zero after a configurable number of sampling points, a credit loss event may be signaled.

FIG. 1B illustrates an example of a scoreboard 120 (e.g., maintained by flow-control credit loss response mechanism 116) for credit loss detection (e.g., performed by flow-control credit loss response mechanism 116) according to an embodiment. Scoreboard 120 shows the information collected at sampling points (shown as t0 to tN, each of which may correspond to an idle state or period) and how a decision may be made based on the sampled information.

Based on the information in scoreboard 120, it may be determined that there was a possible leak of one credit during the transition between t0 and t1. However, during the transition between t1 and t2, one net credit was returned.

It may also be determined that there was a possible leak of one credit during the transition between t2 and t3. It was detected at t4, t5, t6, and t7 that no net credits were returned, for a total of five consecutive sampling points for which L is greater than zero.

Embodiments may provide for a threshold value (e.g., EVENTS_THRESHOLD) to define a number of consecutive sampling points for which L is greater than zero at which credit loss event in a link (e.g., link 114 in FIG. 1A) is to be logged and/or signaled. For example and as shown in FIG. 1B, with the EVENTS_THRESHOLD value set at 5, a credit loss event will be signaled in connection with the sample taken at t7.

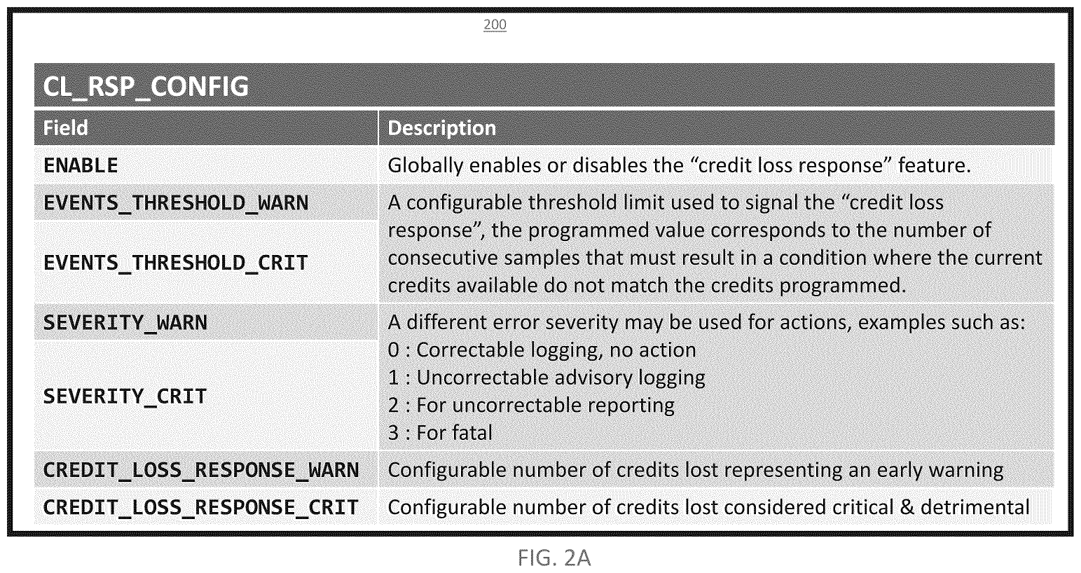

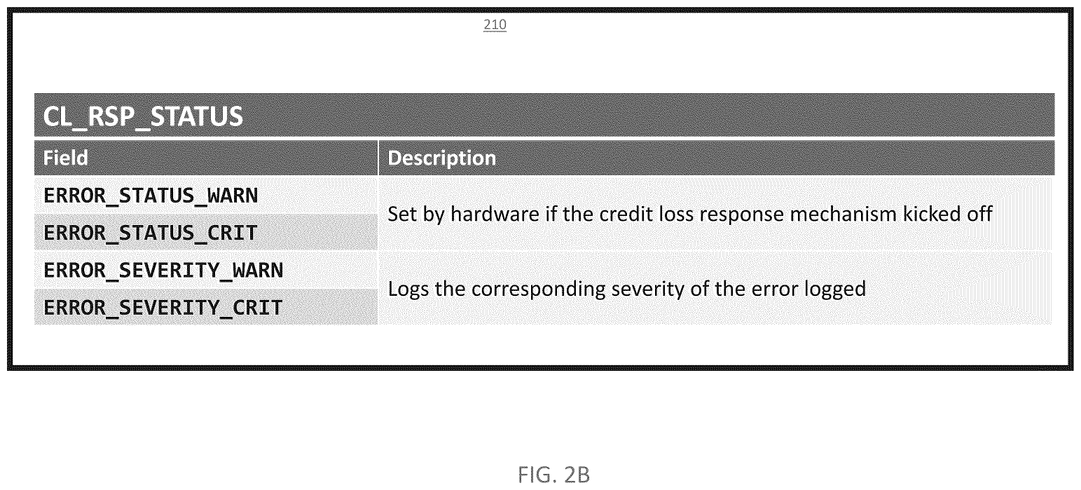

In embodiments, the value of EVENTS_THRESHOLD is configurable by a register policy and is tunable. Embodiments may include one or more such event thresholds (e.g., a warning threshold, a critical threshold, etc.). For example, FIG. 2A illustrates a configuration register 200 for credit loss detection according to an embodiment.

As shown by example in FIG. 2A, embodiments may include a configuration register (e.g., credit loss response configuration (CL_RSP_CONFIG) register 200) or storage location having fields for enabling (e.g., ENABLE) and configuring settings for programmable and tunable credit loss detection (e.g., by flow-control credit loss response mechanism 116) such as a warning threshold limit value (e.g.,
EVENTS_THRESHOLD_WARN) at which to signal a credit loss event warning (e.g., to trigger a credit loss warning response), a critical threshold limit value (e.g.,
EVENTS_THRESHOLD_CRIT) at which to signal a critical credit loss event (e.g., to trigger a critical credit loss response), a warning severity value (e.g., SEVERITY_WARN) to select a severity to be reported in connection with a credit loss event warning, a critical severity value (e.g., SEVERITY_CRIT) to select a severity to be reported in connection with a critical credit loss event, a credit loss response warning value (e.g.,
CREDIT_LOSS_RESPONSE_WARN) to select a number of credits lost to trigger a warning event signal, and a critical credit loss response value (e.g.,
CREDIT_LOSS_RESPONSE_CRIT) to select a number of credits lost to trigger a critical event signal.

As shown by example in FIG. 2B, embodiments may include a status register (e.g., credit loss response status (CL_RSP_STATUS) register 210) or storage location, visible to users for diagnosis, debug, etc., to provide information about credit loss and errors associated with credit loss. As shown in FIG. 2B, such a register may have fields for an error status warning indicator (ERROR_STATUS_WARNING) to be set by hardware (e.g., flow-control credit loss response mechanism 116) to signal that an credit loss warning event has occurred, an error status critical indicator (ERROR_STATUS_CRIT) to be set by hardware (e.g., flow-control credit loss response mechanism 116) to signal that a critical credit loss event has occurred, an error severity warning value (ERROR_SEVERITY_WARN) to log the severity of a credit loss warning event, and an error severity critical value (ERROR_SEVERITY_CRIT) to log the severity of a critical credit loss event.

In embodiments, credit loss detection configuration and status registers or other storage locations may be implemented in one or more I/O controller(s), interconnect controller(s), bridge(s), and/or any other system component(s) than may be accessed by credit loss detection hardware (e.g., (e.g., flow-control credit loss response mechanism 116) and software.

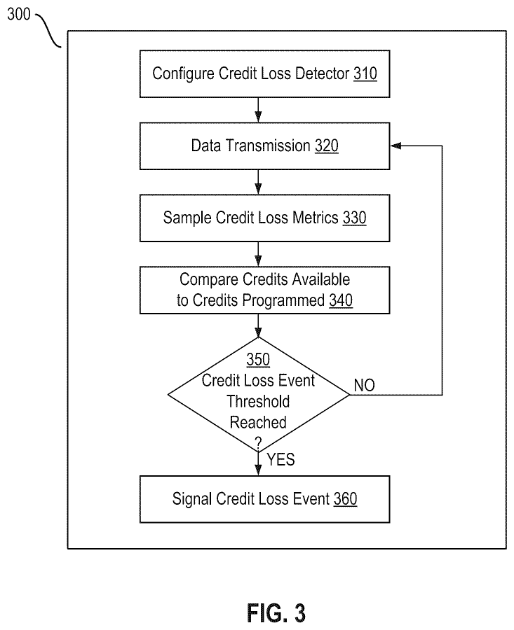

FIG. 3 illustrates a method for flow-control credit loss detection according to an embodiment. Method 300 may be performed by and/or in connection with the operation of an apparatus such as system 100 as shown FIG. 1A; therefore, all or any portion of the preceding description may be applicable to method 300.

In 310, a credit loss detector according to embodiments is configured. In 320, a system including the credit loss detector operates and data is transmitted according to a credit-based protocol. In 330, credit loss metrics, including credits available, are sampled and recorded in a credit loss scoreboard. In 340, credits available is compared to credits programmed, and the result is recorded in the credit loss scoreboard. In 350, it is determined, based on the credit loss scoreboard, whether a credit loss event threshold has been reached. If yes, a credit loss event is signaled in 360. If not, method 300 continues in 320.

Operation based on any threshold (e.g., EVENTS_THRESHOLD, EVENTS_THRESHOLD_WARN, EVENTS_THRESHOLD_CRIT) described above may vary in different embodiments. For example, an action may be taken in response to a threshold being reached or met, in response to a threshold being crossed (in a positive direction (exceeded) or a negative direction), etc.

### Example Apparatuses, Methods, Etc

According to some examples, an apparatus (e.g., a system or system component) includes an interconnect for transmitting data according to a credit-based protocol and a credit loss detector. The credit loss detector is to detect possible credit leaks by sampling credits available, comparing the credits available to credits programmed per sampling point, and maintaining a scoreboard of a result of the comparing per sampling point.

Any such examples may include any or any combination of the following aspects. The apparatus also includes a device connected to the credit loss detector through a credited link for transmitting the data according to the credit-based protocol. The credit loss detector is to sample credits available during idle states. The credit loss detector is to signal a credit loss event in response to a number of consecutive sampling points in which a possible credit leak is detected reaching a threshold value. The apparatus also includes a credit loss detection configuration storage location to store the threshold value. The apparatus also includes a credit loss detection status storage location to store an indicator to be set by the credit loss detector to indicate that a credit loss event has been detected. The credit loss detection status storage location is also to store a severity value to indicate a severity of the credit loss event. The interconnect is a Peripheral Component Interconnect Express (PCIe) interconnect. The interconnect is a Compute Express Link (CXL) interconnect. The interconnect is a Universal Chiplet Interconnect Express (UCIe) interconnect.

According to some examples, a method includes transmitting data according to a credit-based protocol; sampling credits available; comparing the credits available to credits programmed at each sampling point; maintaining a scoreboard of credit loss metrics, including a result of the comparing per sampling point; and determining whether to signal a credit loss event based on the scoreboard.

Any such examples may include any or any combination of the following aspects. The sampling credits available is performed during idle states. The method includes signaling a credit loss event in response to a number of consecutive sampling points in which a possible credit leak is detected reaching a threshold value. The threshold value is stored in a credit loss detection configuration storage location. Signaling the credit loss event includes storing an indicator in a credit loss detection status storage location to indicate that the credit loss event has been detected. Signaling the credit loss event also includes storing a severity value in the credit loss detection status storage location to indicate a severity of the credit loss event.

According to some examples, an apparatus (e.g., a system or system component) includes sampling circuitry to sample credits available for data transmission according to a credit-based protocol; a comparator to compare the credits available to credits programmed per sampling point; and a scoreboard to maintain a result of the comparing per sampling point.

Any such examples may include any or any combination of the following aspects. The sampling circuitry is to sample credits available during idle states. The apparatus also includes signaling circuitry to signal a credit loss event in response to a number of consecutive sampling points in which a possible credit leak is detected reaching a threshold value. The apparatus also includes a credit loss detection configuration storage location to store the threshold value.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, the first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit circuitry 516 couples the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures—In-Order and Out-of-Order Core Block Diagram

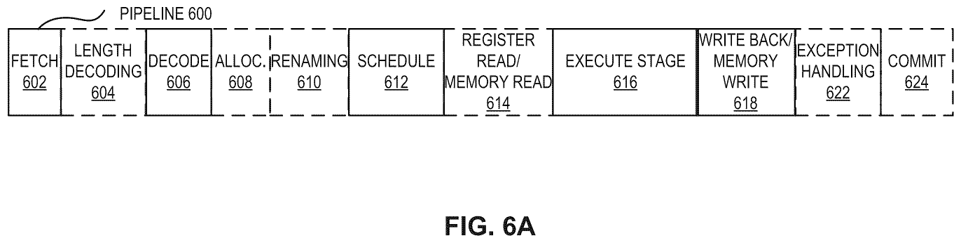

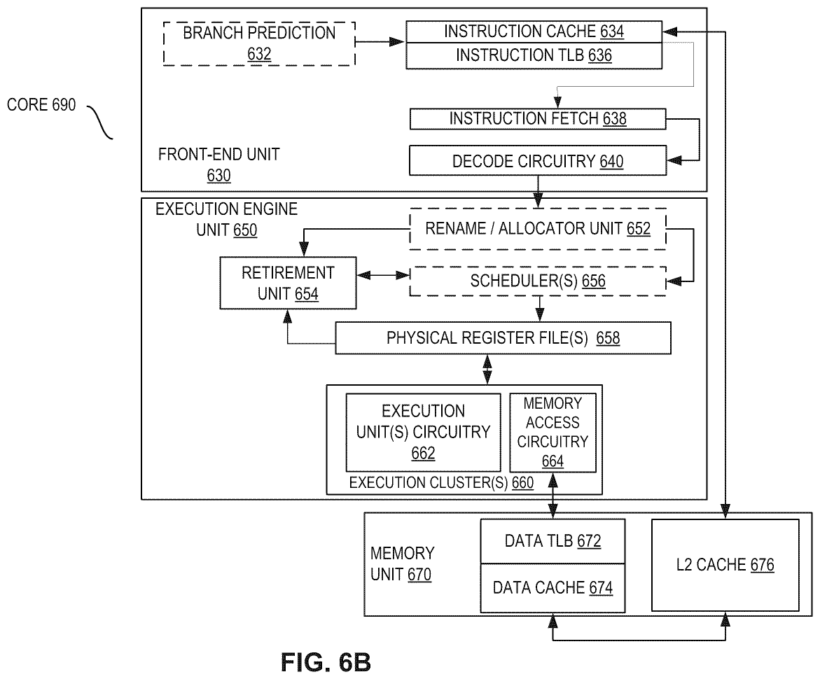

FIG. 6A is a block diagram illustrating both an example in-order pipeline and an example register renaming, out-of-order issue/execution pipeline according to examples. FIG. 6B is a block diagram illustrating both an example in-order architecture core and an example register renaming, out-of-order issue/execution architecture core to be included in a processor according to examples. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6B may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6B shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry

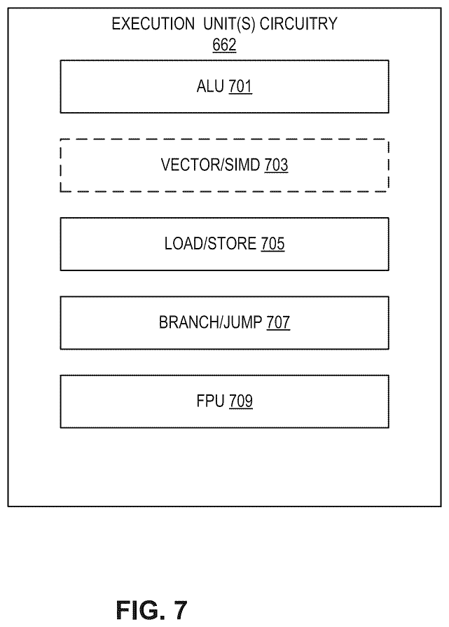

FIG. 7 illustrates examples of execution unit(s) circuitry, such as execution unit(s) circuitry 662 of FIG. 6B. As illustrated, execution unit(s) circuitry 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

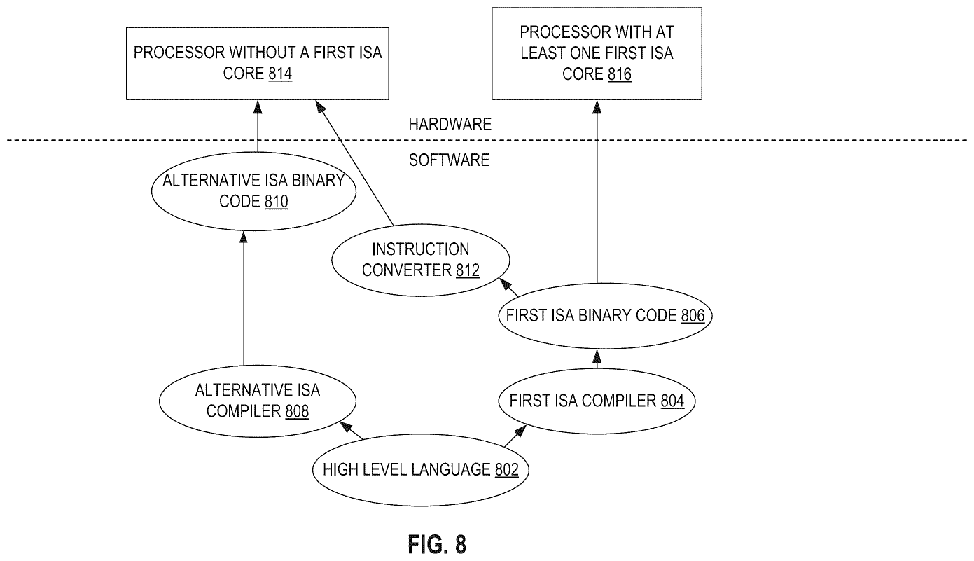

FIG. 8 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 8 shows a program in a high-level language 802 may be compiled using a first ISA compiler 804 to generate first ISA binary code 806 that may be natively executed by a processor with at least one first ISA core 816. The processor with at least one first ISA core 816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 804 represents a compiler that is operable to generate first ISA binary code 806 (e.g., object code) that can, with or without additional linkage processing, be executed on the processor with at least one first ISA core 816. Similarly, FIG. 8 shows the program in the high-level language 802 may be compiled using an alternative ISA compiler 808 to generate alternative ISA binary code 810 that may be natively executed by a processor without a first ISA core 814. The instruction converter 812 is used to convert the first ISA binary code 806 into code that may be natively executed by the processor without a first ISA core 814. This converted code is not necessarily to be the same as the alternative ISA binary code 810; however, the converted code will accomplish the general operation and be made up of instructions from the alternative ISA. Thus, the instruction converter 812 represents software, firmware, hardware, or a combination thereof that, through emulation, simulation, or any other process, allows a processor or other electronic device that does not have a first ISA processor or core to execute the first ISA binary code 806.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases do not necessarily refer to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
an interconnect for transmitting data according to a credit-based protocol; and
a credit loss detector to detect possible credit leaks by sampling credits available,
comparing the credits available to credits programmed per sampling point; and
maintaining a scoreboard of a result of the comparing per sampling point.

2. The apparatus of claim 1, further comprising a device connected to the credit loss detector through a credited link for transmitting the data according to the credit-based protocol.

3. The apparatus of claim 1, wherein the credit loss detector is to sample credits available during idle states.

4. The apparatus of claim 1, wherein the credit loss detector is to signal a credit loss event in response to a number of consecutive sampling points in which a possible credit leak is detected reaching a threshold value.

5. The apparatus of claim 4, further comprising a credit loss detection configuration storage location to store the threshold value.

6. The apparatus of claim 4, further comprising a credit loss detection status storage location to store an indicator to be set by the credit loss detector to indicate that a credit loss event has been detected.

7. The apparatus of claim 6, wherein the credit loss detection status storage location is also to store a severity value to indicate a severity of the credit loss event.

8. The apparatus of claim 1, wherein the interconnect is a Peripheral Component Interconnect Express (PCIe) interconnect.

9. The apparatus of claim 1, wherein the interconnect is a Compute Express Link (CXL) interconnect.

10. The apparatus of claim 1, wherein the interconnect is a Universal Chiplet Interconnect Express (UCIe) interconnect.

11. A method comprising:
transmitting data according to a credit-based protocol;
sampling credits available;
comparing the credits available to credits programmed at each sampling point;
maintaining a scoreboard of credit loss metrics, including a result of the comparing per sampling point; and
determining whether to signal a credit loss event based on the scoreboard.

12. The method of claim 11, wherein the sampling credits available is performed during idle states.

13. The method of claim 11, further comprising signaling a credit loss event in response to a number of consecutive sampling points in which a possible credit leak is detected reaching a threshold value.

14. The method of claim 13, wherein the threshold value is stored in a credit loss detection configuration storage location.

15. The method of claim 13, wherein signaling the credit loss event includes storing an indicator in a credit loss detection status storage location to indicate that the credit loss event has been detected.

16. The method of claim 15, wherein signaling the credit loss event also includes storing a severity value in the credit loss detection status storage location to indicate a severity of the credit loss event.

17. An apparatus comprising:
sampling circuitry to sample credits available for data transmission according to a credit-based protocol;
a comparator to compare the credits available to credits programmed per sampling point; and
a scoreboard to maintain a result of the comparing per sampling point.

18. The apparatus of claim 17, wherein the sampling circuitry is to sample credits available during idle states.

19. The apparatus of claim 17, further comprising signaling circuitry to signal a credit loss event in response to a number of consecutive sampling points in which a possible credit leak is detected reaching a threshold value.

20. The apparatus of claim 19, further comprising a credit loss detection configuration storage location to store the threshold value.
